(19) United States
(12) Patent Application Publication
(10) Pub. No.: US 2009/0228974 A1
(43) Pub. Date: Sep. 10, 2009

(54) CONFIGURATION DEVICE AND METHOD

(75) Inventor: CHRISTO IVANOV, Hamburg (DE)

Correspondence Address: WOLF GREENFIELD & SACKS, P.C., 600 ATLANTIC AVENUE, BOSTON, MA, 02210-2206, US

(73) Assignee: gateProtect Aktiengesellschaft Germany, Hamburg (DE)

(21) Appl. No.: 12/354,447

(22) Filed: Jan. 15, 2009

(30) Foreign Application Priority Data
Mar. 4, 2008 (DE) 102008012386.2

(51) Int. Cl. G06F 21/00

(52) U.S. Cl. 726/15

(57) ABSTRACT

Configuration device 10 for configuring a plurality of firewall devices 12 which are positioned in at least one computer network 11, comprising: a display device 15 for depicting firewall symbols 20 representing firewall devices 12 in an arrangement representing the actual spatial location relation of the firewall devices 12; for depicting line symbols 21 representing VPN tunnels between mutually connected firewall devices 12, and for depicting VPN symbols 22 representing VPN tunnel setting entities on or at the line symbols 21, a selection device 17 for selecting firewall devices 12 and VPN tunnel setting entities through their firewall symbols 20 and VPN symbols 21, on the display device 15, a firewall rule editing unit 18 for editing a configuration and/or rules of a selected firewall device 12, based upon starting configuration data and starting rules for the selected firewall device, received via the computer network, and a VPN tunnel editing unit 19 for editing the settings of a selected VPN tunnel setting entity, based on starting settings for the selected VPN tunnel from the firewall devices 12 participating in the VPN tunnel, which are received via the computer network 11.

### BACKGROUND OF THE INVENTION

Today's computer networks are generally connected via different kinds of communication lines to each other and to the Internet. Due to high data capacities provided by the Internet providers there has been a strong tendency in recent years to not connect the particular sub-networks within companies via rented specialized lines, but via the Internet, using so-called virtual private network strategies in which a secure connectivity link for transmitting data packets between two locations using a normal Internet connection as well as security mechanisms such as ciphering and authentication are used. To prevent intrusion from outside persons into such company networks or individual computers connected to the Internet in some manner, so-called firewalls have been developed which monitor data traffic through a particular interface and which are to prevent the transmission of illegitimate data packets into a corporate network, or a request for data categorized as sensitive within the network. The technology of firewalls has been continuously improved in recent years and several development stages must be discriminated which range from very simple monitoring mechanisms, such as enabling and disabling certain “TCP ports” at certain IP addresses, up to very complex monitoring instruments, which perform a semantic analysis of the data traffic passing through the firewalls. Configuring and maintaining firewalls and VPN tunnel connections has accordingly now turned into a complex task. In larger corporate networks numerous firewalls are often employed in order to mutually connect the diverse company locations. A central administration of these firewalls, as a rule also via the Internet, facilitates setting and changing the desired filter and monitoring as well as data exchange functions for system administrators. These usually give an overview of the firewalls existing in a corporate network or of individual external computers in the form of lists or tables and then allow by further lists or input fields the respective individual configuration of the diverse firewalls, where generally the internal administrative structure of the firewalls in regard to IP ports and target/starting addresses is reflected in those programs windows or lists, which turns out to be of little help when mastering complex setups, since the system administrator must always keep in mind the overall layout of the networks and the required individual connections and their configurations.

### SUMMARY OF THE INVENTION

It is therefore the object of the present invention to provide an approach with which management of firewalls in a corporate network interlinked via the normal Internet, for example with several locations, and protection of a corporate network against outside attacks, is provided in a more intuitive and process-oriented fashion.

According to the invention, this object is solved by the configuration device according to independent claim 1, the system according to independent claim 28, as well as the configuration method according to independent claim 15.

Further advantageous embodiments, details and aspects of the present invention follow from the dependent claims, the description and the appended drawings.

Accordingly, the invention is first of all directed to a configuration device for configuring a plurality of firewall devices which are positioned in at least one computer network. The configuration device comprises:

a display device for depicting firewall symbols representing firewall devices in an arrangement representing the actual spatial location relation of the firewall devices; for depicting line symbols representing connecting lines between mutually connected firewall devices, and for depicting VPN symbols representing VPN tunnel setting entities between firewall devices connected via VPN tunnels.

The configuration device according to the invention furthermore comprises a selection device for selecting firewall devices or VPN tunnel setting entities through their firewall symbols and VPN symbols, on the display device. Finally, the configuration device comprises at least two rule editing units, i.e. on one hand a firewall rule editing unit for editing a configuration and/or rules of a selected firewall device, wherein the editing is based upon starting configuration data and starting rules for the selected firewall device, and those are received via the computer network, and on the other hand a VPN tunnel editing unit for editing the settings of a selected VPN tunnel setting entity, wherein this editing is based on starting settings for the selected VPN tunnel from the firewall devices participating in the VPN tunnel, which are received via the computer network.

A firewall device within the meaning of the present invention is any entity which may find application as a firewall in the usual meaning of this term, for example a program running on a computer which is supposed to protect this computer (internal firewall), a general purpose computer acting as a gateway with corresponding software, or specialized apparatus having a firewall functionality, including complex firewall devices or NAT (network addressed translation) routers, etc. The configuration device may be a specialized device, the hardware of which is adapted for performing the inventive methods, and it may comprise corresponding hardware entities which provide the respective functionalities, or it may be a software which is executed on a general-purpose computer integrated into the computer network(s) containing the firewall devices, in a suitable manner.

The display device includes any kind of viewing screen as well as all functions required for depicting the variety of symbols and for determining the arrangement of the symbols on the display in a spread-out manner, and is in no way restricted to specialized hardware or software. An actual spatial location relation is the relative orientation of the locations of all the firewall devices, for example in relation to the earth's surface. It goes without saying that due to the limited precision of the depiction, approximations may or must be employed here. Furthermore, additional effects may have to be considered, as for example overlaps of symbols with partial networks positioned close to each other, which are to be avoided, for example in particular modes of depiction. Symbols are to be understood as two-dimensional or planar depictions on the viewing screen which will in some manner show a correlation, recognizable or learnable by users, with regard to the physical or logical devices they depict. Symbolic firewalls and VPN symbols may also be designated as “icons” within the usual meaning of this term. The firewall symbols are sensibly selected to resemble actually used firewall devices so that here differences among the symbols may occur in a firewall-manufacturer-specific manner. The VPN symbols are in one possible embodiment small rectangles, rhombuses, circles, etc. which may be arranged on the line symbols or may be arranged close to the line symbols, so that it becomes clear to the user that these symbolize the VPN setting entity for the connection linked by the line symbol.

The selection device may be a common device for the operation of the display device, as for example a keyboard for moving a cursor on the viewing screen of the display device, a mouse, a touch sensitive area on the display, etc. The selection device must generally also have, aside from the ability for positioning, an ability to determine the act of selection, for example a mouse key.

A VPN tunnel within the meaning of the present invention is to be understood as a VPN tunnel as is known to skilled persons, i.e. a virtual linkage between two computers which have mutually agreed on a transmission protocol and the required ciphering keys and which most often also exchange, before effecting the linkage, so-called certificates. The term VPN tunnel is known to skilled persons.

A particularity of the invention is the possibility for interactively starting editing units via the selection device, in order to allow for intuitively managing certain firewall devices or VPN tunnels. By a geographically approximated depiction of the firewall devices and a screen depiction of VPN tunnels located between them, the system administrator can select a device or a tunnel, to be worked on, in the simplest possible manner, and the pertaining rule editor is automatically started or activated. Rule editing units for editing the firewall configurations employ configurations and/or rules. A configuration is understood to include any information stored on a firewall device and determines the basic actions and behaviors of the firewall in respect to its environment. In contrast, rule sets are any information determining how the firewall devices will treat inbound or outbound data packets, also depending on a target address. The term setting entity used in connection with the VPN tunnels characterizes all. settings which are to apply to a given VPN tunnel. In turn, settings are understood to be behaviors and required information which are supposed to determine the mode of operation of this kind of logical link between computers. This comprises IP addresses and domain names, cipher algorithms used, as well as certificates, but this is not to be understood as a restriction, as well as further settings for VPN tunnels generally known to skilled persons.

In a preferred embodiment the editing units, i.e. the VPN tunnel editing unit and the firewall rule editing unit, are configured for depicting the configuration data, rules and/or settings as well as their editing function on the display device. Thus, each of the editing units (other editors are imaginable, too) uses a portion or the whole of the display device for fading-in the required information. In practice, this will be often implemented in a way that above the main window showing the diverse symbols and further information, smaller fade-in windows are overlaid serving for depicting and manipulating information from the editing units.

In a further preferred embodiment of the invention, the display device comprises a zooming unit for size-variable depiction of the symbols (and of other geographically related elements) on the display device and the display device is configured for changing the depiction—with increasing size smoothly and/or in stages—of the firewall symbols, and if need be, of the length and potentially thickness of the line symbols and/or VPN symbols in a way that an increasing number of information with respect to configurations and/or partial rule sets of the logical elements within the firewall devices on the display area of the firewall symbols are depicted. In the majority of the cases, firewall devices are complex combinations of hardware and software configuration. They serve to filter numerous computers and, partially depending on computers, the allowed types of data transfer from the computers to other firewalls, to computers of individual users or to networks not protected by a firewall. According to the invention, this complex framework of configurations of users and rule sets for the processes of data flows within a firewall device is entirely according to the process oriented approach, likewise implemented with symbols representing the different elements constituting the overall system of a firewall device on the display area. For example, there may be depicted symbols for single users, as well as connecting lines of logical connections between such users or groups of users and other users outside the firewall or also within a network, very diverse symbols contribute thereto.

A “display area of a firewall symbol” is understood to be the region of a viewing screen or the display window with the symbol detection, for depiction of the symbols. With a particular depiction, this region has certain coordinates. Within this range of coordinates, a region may be provided (which may comprise the whole region), within which a detailed depiction of internal firewall connections and end points, etc. is made. Upon clicking within this region (which may also deviate from the actually visible icon depiction), selection of the icons will be recognized or, with a detailed depiction the selection of one symbol, will also be recognized, which is depicted on a sub-region of the display area.

The rule sets on which each of the logical connections is based are preferably also depicted according to the invention, for example in a way similar to the setting unit for the VPN tunnels, by small symbols, such as rectangles, rhombuses, circles, etc. arranged at the connecting lines. The depiction of these elements within the overall function of a firewall device should in a preferred embodiment be depicted with more or less detail, depending on the zooming degree. Here, it is imaginable that starting at a predetermined enlargement degree, or also within several stages, a further group of elements is depicted each time in detail and the elements are continuously enlarged, when further zoomed in, until a further enlargement stage is reached. In this manner, the system administrator is presented, upon zooming into a particular firewall device, an ever increasing degree of details of the inner configuration and the rules associated therewith, and this allows an overview to be quickly achieved on each of the depicted firewall devices.

In particular, the information on the display area of each of the firewall symbols may comprise sub-rule symbols representing sub-rule sets having rules for each of the logical connections between computers and a computer network. Also, it is preferable that the selection device furthermore is for selecting sub-rule sets via their sub-rule symbols on the display area of the firewall symbols and that the configuration device furthermore comprises: a sub-rule editing device for editing the configuration of a selected sub-rule set, based on initial configuration data and rules for the selected sub-rule set which are received from the firewall device, to which the sub-rule set belongs, via the computer network. A sub-rule set within the meaning of the present invention is to be understood, as already indicated above, as a sub-set of all the rules which exist in a firewall device, which comprise a particular logical connection between terminals which may, for example, be uniquely defined through their IP addresses.

In a preferred embodiment, the configuration device according to the invention furthermore comprises a VPN tunnel set-up unit for setting up and configuring settings of a new VPN tunnel between at least two firewall devices which will automatically start after activating the VPN tunnel set-up unit by the selection device by means of successive selecting of firewall symbols of two firewall devices to be mutually connected. For example, by selecting a specific mode (e.g. a line tool for making connection lines) and, when using a mouse, successively clicking on both firewall devices to be mutually connected, the VPN tunnel set-up unit, a so-called “Wizard”, is automatically started, which successively requests the required information on settings to be made for setting up a VPN tunnel between the two clicked firewall devices from the firewall devices (provided this information is not yet present in the configuration device) and presents this set-up information to the system administrator, for example, in a window which is faded in on the viewing screen of the display device, who may then perform the required settings for establishing a VPN tunnel. In addition to sub-networks which are protected against external intrusion and the Internet through firewalls, there are frequently individual users in corporations who, for example, work in the field or at home. These too must be embedded into a network in a secure manner. For this purpose, again VPN tunnels are employed, which are however not established between two firewall devices, but between a firewall device and a single computer.

To take account of this, it is devised that in a preferred configuration device according to the invention the display device is furthermore provided for the depiction of user devices which are not firewall protected, for example PCs, PDAs, cellular phones, etc. represented by user symbols in an arrangement on the display device in a relation representing their actual spatial location relation, and the line symbols also serve for depicting VPN tunnel connections between the user devices and the firewall devices. It goes without saying that this concept, which also takes account of the actual spatial site relation, is not possible with mobile users having permanently changing locations. Here, it would, for example, be imaginable to instead provide a reserved region on the screen of the display device, in which all mobile users are symbolized, so that it is known that this part of the display device does not participate in the depiction of the spatial site relations.

The configuration device preferably comprises furthermore a user set-up unit for setting up and configuring a new VPN tunnel between a firewall device and a user device, which is for an automatic start after activating user set-up units with the selection device by successively selecting the symbols of the firewall device and the user device to be mutually connected (preferably in an arbitrary order). After starting, the user set-up unit can read-in the starting settings from the devices participating in the VPN tunnel to be set up, i.e. the firewall device and the user device, and can reconfigure settings and/or security certificates, etc., which are necessary for the correct set-up of a VPN tunnel, in the devices, after their set-up by a system administrator for the user settings.

In a further preferred embodiment, the VPN tunnel set-up unit and/or the user set-up unit, upon enlargements of the depiction in the display unit, in which information with respect to configuration and the rule sets within the firewall devices (display area) of the firewall symbol is depicted, is also activatable when selecting logical elements and/or sub-rule sets within the display area of firewall symbols and is for automatically linking such internal logical elements with logical elements in this or other firewall devices. In this manner, the flexibility of the inventive approach is further increased, since not only between firewall devices and a firewall device and end users can VPN tunnels be established, but the individual firewall devices and the individual components thereof can also be directly entered, and starting therefrom, VPNs or other connections of any kind may be established.

In a further preferred embodiment of the present invention, the display device comprises a correlation unit arranged for determining the positioning of the symbols belonging to the devices and, derived therefrom, of connecting lines and their VPN symbols on the display device, by means of site location data from the firewall devices and the user devices.

Generally, there are different approaches for determining a concrete arrangement of the individual elements, and in particular the firewall symbols, on the display area of the display device. One approach is that the system administrator moves the icon belonging to each newly set-up firewall device interactively on the display, for example by means of his mouse, as long as according to his disposition it is arranged in a spatially correct position. A further possible approach is to provide within the configuration devices themselves a data base, or a list, etc., in which for each firewall device registered by the configuration device a location information is entered, for example by giving latitude and longitude (WGS 84 etc.) which is then used for calculating the depiction. In a third approach also preferred, as set forth above, the information on the actual location of a firewall device originates from the device itself. Here too several possibilities are available. E.g., the system administrator who has installed the firewall device at a location may enter these data at a firewall device after having measured or looked up its location, for example in a specially provided data area, which in turn may be retrieved by the configuration device if need be. Alternatively, it is also possible to provide the firewall devices with localization devices which can determine location data autonomously, for example by means of a GPS receiver. This simplifies the work of the system administrator further, however requires a possibility for GPS localization at the location of the device. Other, less satellite-view-dependent methods, for example a WLAN localization by means of known WLAN coordinates, are also imaginable.

In a further preferred embodiment, the depiction comprises an underlaid mapping depiction upon which the firewall devices and/or the user devices are arranged corresponding to their actual spatial site relation. It is to be understood that different maps are usable, for example to depict differing grades of details at differing zoom functions or for detecting different regions of the world maintaining acceptable file sizes for the maps. Suitable maps are available and can be obtained for a fee and the skilled person is aware of pertinent formats of maps from geo-information systems.

In a further aspect the invention is directed to a method for configuring firewall devices and relations between firewall devices in a computer network, the method comprising the steps:
depicting of firewall symbols representing firewall devices in an arrangement representing their actual spatial relation, of line symbols representing VPN tunnels between interconnected firewall devices as well as VPN symbols representing VPN tunnel setting entities on or at the line symbol, on a display device;
after selecting a firewall symbol on the display device by a system administrator, starting a firewall rule editing unit for editing a configuration and/or rules of a selected firewall device, based on initial configuration data and rules for the selected firewall device which are received through the computer network; and/or
after selecting a VPN symbol on the display device by a system administrator, starting a VPN rule editing unit for editing settings of a selected VPN tunnel setting entity, based on initial settings for the selected VPN tunnel from the firewall devices participating in the VPN tunnel, which are received through the computer network.

With respect to the method, all that was said above regarding the configuration device applies likewise and vice versa so that mutual reference is made.

The method includes the two alternatives of the operation of configuring a VPN tunnel and of configuring a firewall, which are each executed after selecting the symbols (icons) on the viewing screen of the display device.

Here, executing can either mean starting a corresponding software program when implementing the method in a computer or a micro controller, or likewise switching on a device which is specifically constituted for executing the method. Depending on the intended use and desired flexibility and robustness, the skilled person will chose a software or a hardware solution, being knowledgeable with regard to the criteria for determining this selection.

Preferably, in a further step the writing back of the configuration, rules and/or settings changed by the system administrator using the firewall rule editing unit and/or the VPN tunnel editing unit to the concerned firewall devices is performed. Alternatively, it can also be conceived that the firewall devices pull in regular intervals configuration data from the configuration device used with the method, so that no active writing back has to take place.

Preferably, configuration data, rules and/or settings as well as possible editing functions are depicted on the display device, for example in overlay or fade-in windows of a graphic user interface. Other detections are of course conceivable and include e.g. acoustical or optical light signals.

In a particularly preferred method the depiction of the symbols, i.e. inter alia the firewall symbols, the line symbols, the VPN symbols, but also other symbols and pictorial elements involved in depiction is enlarged or reduced on the display device, with the firewall symbols being depicted in an altered manner with increased size in steps or smoothly, so that an increasing amount of information on the configuration and/or sub-rule sets of the logical elements within the firewall devices are depicted on display regions of the firewall symbols. This important aspect of the invention, as has already been described in detail with respect to a configuration device, constitutes a significant simplification when viewing and managing firewall symbols since the relation within the elements and between the firewalls, etc. of the entire system can be made clear in a natural manner to the system administrator.

Preferably sub-rule symbols representing sub-rule sets with rules for individual logical connections between computers (e.g. more specifically, between IP addresses) in the computer network are depicted on the display area of each firewall symbol.

In a preferred aspect of the invention, the method may comprise the following further steps:
selecting sub-rule sets by means of their sub-rule symbols on display areas of the firewall symbols; and
editing the configuration of a selected sub-rule set based on initial configuration data and rules for the selected sub-rule set (if necessary analogically interpreting the capability of the terms as in the rule set), which are received from the firewall device to which the sub-rule set belongs, via the computer network.

Further, the method preferably may comprise the following steps:
activating a mode for setting up connections between firewall devices;
successively selecting the symbols of at least two firewall devices to be mutually connected; and
starting a VPN tunnel setup unit for setup and configuration of a new VPN tunnel between the selected firewall devices.

It is also preferred that the VPN tunnel setup unit performs the following steps after being started:
retrieving the initial settings from the firewall devices participating in the connections to be set up, and
reconfiguring the settings and/or the security certificates at the firewall devices after setup by a system administrator for the VPN tunnel configuration.

In addition to the depictions of symbols on a viewing screen of the display device described above, it is preferred that also symbols representing user devices which are not firewall protected are depicted on the display device in an arrangement representing their actual spatial location relation; and the line symbols may also serve to depict VPN tunnel connections between user devices and firewall devices.

With respect to what was said in regard to the actual spatial location relation and its limits, reference is made to the configuration device. It should be noted that a precise maintenance of the actual spatial location relations is becoming ever more difficult with increasing number of symbols to be depicted and that with a large number of user symbols, when there are a lot of in-field workers, there will eventually arise the need for compromises.

The line symbols which are to also serve for depiction of VPN tunnels between end users and firewall protected networks may have an identical appearance as those for connection between particular firewall devices, may however for a clearer discrimination between these two different kinds of VPN tunnels also be depicted differently, be this by depiction with different colors or by changing the line structure as such (dotted, double-line, dashed). In line with the additional depiction, in a preferred embodiment, the inventive method will also be extended by the following steps:
activating a mode for establishing connections between at least one firewall device and at least one user device;
successively selecting the symbols of the firewall device and user device to be mutually connected; and
starting a user setup unit for setting up and configuring a new connection between the selected firewall device and the selected user device.

Preferably, upon enlarging the depiction on the display unit in which information on configurations and rule set content of the firewall devices are depicted, the VPN tunnel setup unit and/or the user setup unit are also started upon selection of logical elements and/or sub-rule sets within the display area of firewall symbols and an automatic link between such internal elements will be established with elements in this or other firewall devices.

Within the meaning of the invention, an automatic link is to be understood in that by means of a setup unit, etc., the required configuration data are provided as far as possible and the system administrator just needs to input the information required for the connection as such and thereafter the configuration for establishing the connection is enabled by writing back or polling of the settings so devised to the involved participants without further activities of the system administrator.

The method preferably comprises the further step:
determining the positioning of the symbols belonging to the devices and deduced therefrom, of connecting lines on the display device by means of location data from the firewall devices and the user devices.

Hence, this embodiment provides that the user devices are also in some way included with respect to their locations, be that on the part of the configuration device or on the part of the user device itself.

The inventive method may preferably comprise the following further steps:
in the firewall device, determining a present location of the firewall device by means of localization device, such as a GPS receiver, etc., in the firewall device; and
making available the information on the location at the configuration device, for determining the positioning of symbols on the display unit.

In yet a further aspect, the invention is directed at a computer network security system which comprises a plurality of firewall devices which may be physically and/or logically connected, and at least one of the inventive configuration devices.

In further aspects, the invention is implementable via a program code to be executed on a data processing facility. One example for such a program code for a configuring of firewall devices and relations between firewall devices in a computer network may comprise the program steps:
depicting firewall symbols representing firewall devices in an arrangement representing their actual spatial relation, line symbols representing VPN tunnels between interconnected firewall devices as well as VPN symbols representing VPN tunnel setting entities on or at the line symbol, on a display device;
after selecting a firewall symbol on the display device by a system administrator, starting a firewall rule editing unit for editing a configuration and/or of rules of a selected firewall device, based on initial configuration data and rules for the selected firewall device which are received through the computer network; and/or
after selecting a VPN symbol on the display device by a system administrator, starting a VPN rule editing unit for editing settings of a selected VPN tunnel setting entity, based on initial settings for the selected VPN tunnel from the firewall devices participating in the VPN tunnel, which are received through the computer network.

The program code may have the further programming step:

writing back of the configuration, rules and/or settings changed by the system administrator using the firewall rule editing unit and/or the VPN tunnel editing unit to the concerned firewall devices.

The configuration data, rules and/or settings as well as possible editing functions may be depicted on the display device via the program code.

Depiction of the symbols on the display device is e.g. enlarged or reduced by the program code, and the firewall symbols are depicted in an altered manner with increased size in steps and/or smoothly, so that an increasing amount of information on the configuration and/or sub-rule sets of the logical elements within the firewall devices are depicted on display regions of the firewall symbols.

The program code may be characterized in that sub-rule symbols representing sub-rule sets with rules for individual logical connections between computers in the computer network are depicted on the display area of the display device.

Furthermore, the program code may comprise the further program steps of:
selecting sub-rule sets by means of their sub-rule symbols on display areas of the firewall symbols; and
editing the configuration of a selected sub-rule set based on initial configuration data and rules for the selected sub-rule set (if necessary analogically interpreting the capability of the terms as in the rule set), which are received from the firewall device to which the sub-rule set belongs, via the computer network.

The program code also may comprise the following program steps:
activating a mode for setting up connections between firewall devices;
successively selecting the symbols of at least two firewall devices to be mutually connected; and
starting a VPN tunnel setup unit for setup and configuration of a new VPN tunnel between the selected firewall devices.

Furthermore, the program code may be characterized in that the VPN tunnel setup unit performs the following steps after being started:
retrieving the initial settings from the firewall devices participating in the connections to be set up, and
reconfiguring the settings and/or the security certificates at the firewall devices after setup by a system administrator for the VPN tunnel configuration.

Also, the program code may be characterized in that furthermore symbols representing user devices which are not firewall protected are depicted on the display device in an arrangement representing their actual spatial location relation; and the line symbols may also serve to depict VPN tunnel connections between user devices and firewall devices.

The program code may also have the following program steps:
activating a mode for establishing connections between at least one firewall device and at least one user device;
successively selecting the symbols of the firewall device and user device to be mutually connected; and
starting a user setup unit for setting up and configuring a new connection between the selected firewall device and the selected user device.

The program code may also be characterized in that, upon enlarging the depiction on the display unit in which information on configurations and rule set content of the firewall devices are depicted, the VPN tunnel setup unit and/or the user setup unit are also started upon selection of logical elements and/or sub-rule sets within the display area of firewall symbols and an automatic link between such internal elements with elements in this or other firewall devices is established.

The program code may also be characterized by comprising the further step:
determining the positioning of the symbols belonging to the devices and deduced therefrom, connecting lines on the display device by means of location data from the firewall devices and the user devices.

Finally, the program code may also be characterized in that the program comprises the further program steps:
in the firewall device, determining a present location of the firewall device by means of localization device, and
making the information on the location at the configuration device available for determining the positioning of symbols on the display unit.

### BRIEF DESCRIPTION OF THE DRAWINGS

FIG. 1 shows an overall system of configuration, network and firewall devices according to the invention;

FIG. 2 shows a more detailed depiction of the inventive configuration device in preferred embodiments with a variety of functional elements;

FIG. 3 shows the size variable depiction of the use symbols;

FIG. 4 shows the approach when configuring an existing VPN tunnel connection;

FIG. 5 shows the setup of a new VPN tunnel connection by means of a “wizard”;

FIG. 6 shows the initialization of the configuration device and output of the depicted symbols on the viewing screen thereof;

FIG. 7 shows a basic mode of operation according to the inventive method; and

FIG. 8 shows a flowchart for explaining the function of the VPN tunnel setup unit (“VPN wizard”).

### DETAILED DESCRIPTION OF THE PREFERRED EMBODIMENTS

In the following, the invention will be explained in more detail by means of further detailed information and somewhat more specific examples, with reference to the appended drawings, in which the following is shown:

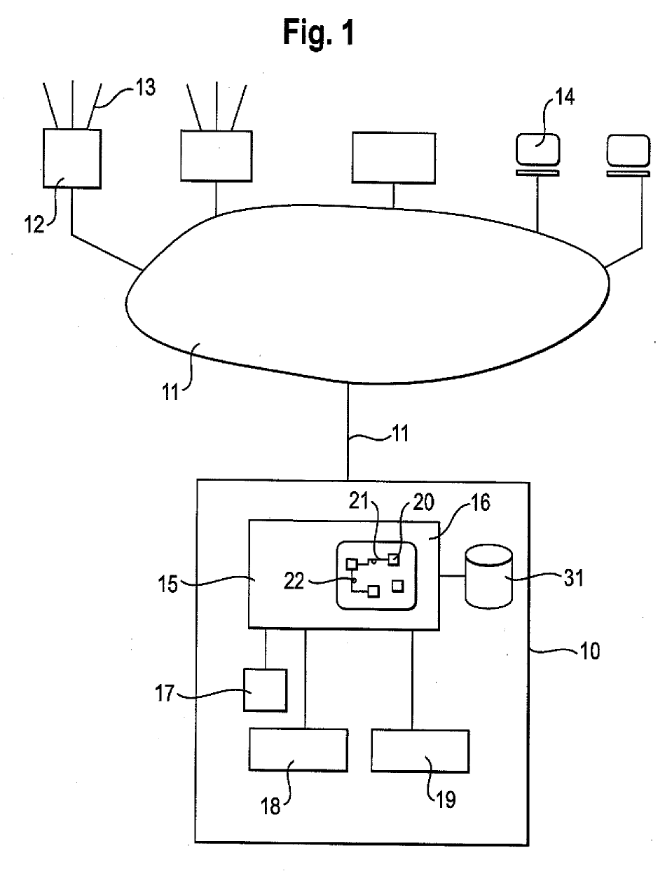

FIG. 1 shows the basic principles of the present invention in highly schematic form. It is an inventive configuration device for firewall devices 10 which is connected through a network 11 to a plurality of firewall devices 12 which are in turn connected to an internal network. Furthermore, there are individual users 14 who can also be integrated into the network. Typically the network is the Internet, but may also be a different network in which firewalls are to be used.

The configuration device 10 consists of a display device 15 which in addition to the usual elements of such a display device, such as a central processing unit, hardware or software implemented functionalities, also has a viewing screen for depicting information, which is designated by 16. A selection device 17 is to manipulate a cursor or a comparable display apparatus on the viewing screen of display device 15 and may, for example, be a mouse, a keyboard, a touch sensitive region of the viewing screen, etc. All conceivable selection and user interaction devices which allow a graphic interaction via a viewing screen may be employed. A database 31 can be used for storing all the data to be stored in the configuration device.

A firewall rule editing unit 18 and a VPN tunnel editing unit 19 are provided. These units, also generally designated as editors may in principle be implemented as hardware-based ASICs etc., they will however in the majority of cases, for cost and flexibility reasons, be implemented by programs which are executed on a processor of the configuration device. As an exemplary depiction of a firewall network, viewing screen 16 shows a total of 4 firewall symbols (“icons”) formed as rectangles and each symbolizing one firewall. These firewall symbols 20 are mutually connected via connection lines 21 symbolizing the VPN tunnels. Approximately in the middle of each VPN tunnel, there is a symbol for a VPN tunnel setting entity 22. Both the firewall device symbols 20 and the VPN symbols 22 are so-called “hot” icons, i.e. they are underlaid by a well-known functionality which results in an action by, for example, clicking or otherwise selecting within the area of the display area for the respective symbol, the activity when clicking in the display area of symbol 20 leading to the invocation of the rule editor for firewalls, while clicking within the display area of VPN symbol 22 leads to the invocation of VPN tunnel editor 19.

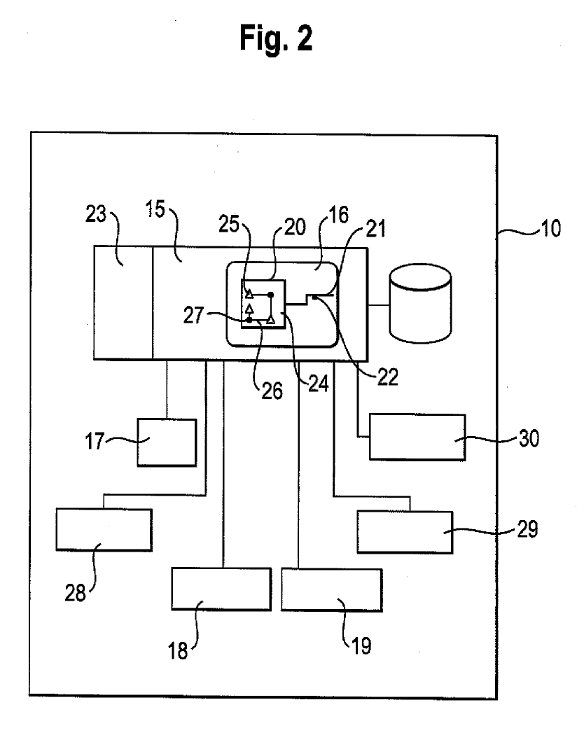

FIG. 2 shows an expanded depiction of the configuration device 10 from FIG. 1 in further improved, preferred embodiments of the invention. For example, to the display device 15 is added a zooming device 23 which allows the depiction on the viewing screen to be scaled. As an example and in no way restricted thereto an enlarged depiction is accordingly shown on the viewing screen 16, in which a firewall 20 has a display area 24, upon which in turn smaller symbols are depicted which refer to the inner configuration of the firewall and which also consist of icons 25 (exemplarily shown as triangles) symbolizing persons, IP addresses or services, and connecting lines therebetween which show logical connections 26 as well as pertinent sub-rule sets 27 which are shown as dots on the connecting lines in an analogue manner to the VPN tunnel setting entities.

The degree of detail with which the sub-components of the firewall symbol 22 are depicted on the display area 24 may depend on the degree of enlargement which has presently been elected. The degree of enlargement may be set via a specific input device or via the selection device in combination with a sub region of the viewing screen which provides a functionality for enlarging and reducing the detail view. In order to make configurations within the sub-rule sets, this configuration device includes in addition to the elements shown in FIG. 1, a sub-rule set editing device 28 with which the icons on the display area 24 can be clicked. It is likewise conceivable that for the different kinds of connections and the different symbols, different rule editors are respectively used.

Furthermore, FIG. 2 shows further preferred embodiments, i.e. a VPN tunnel setup unit 29 which is also designated as VPN wizard and which contributes to establishing and configuring new VPN tunnels between firewall devices. Finally, a user setup unit 30 is shown which is intended for the connection of a VPN tunnel between a firewall and a computer of an end user not firewall protected, for example an in-field employee. It should be noted that the VPN wizard 29 and the user setup unit 30 may also be implemented within one unit as both exhibit similar functionalities.

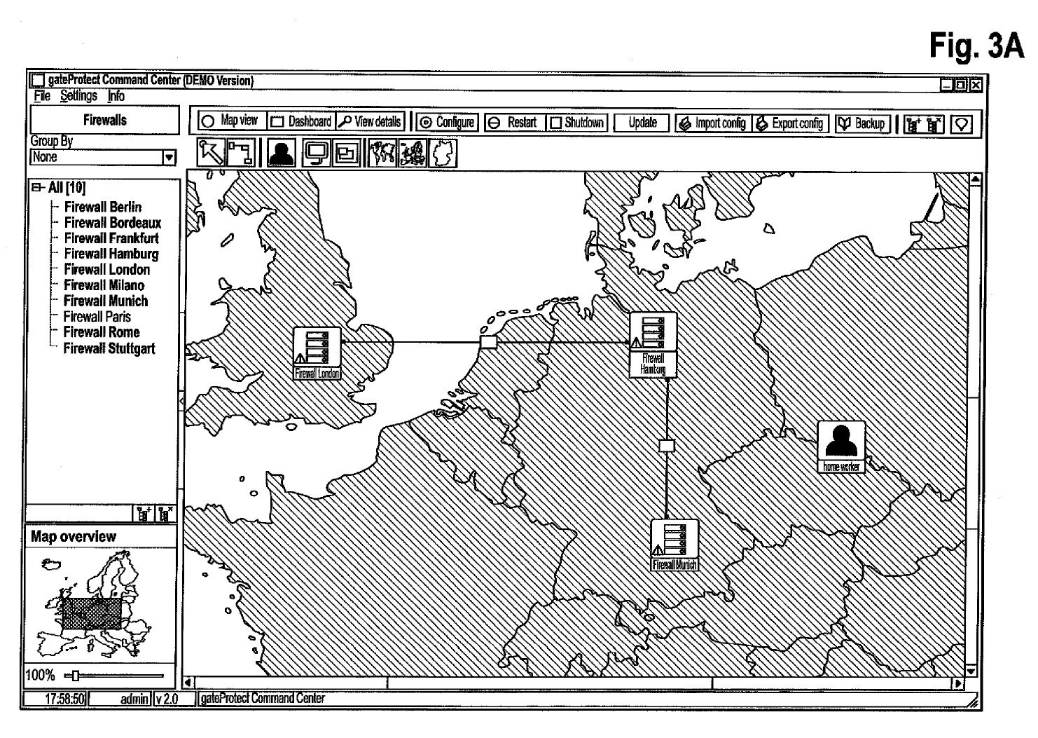

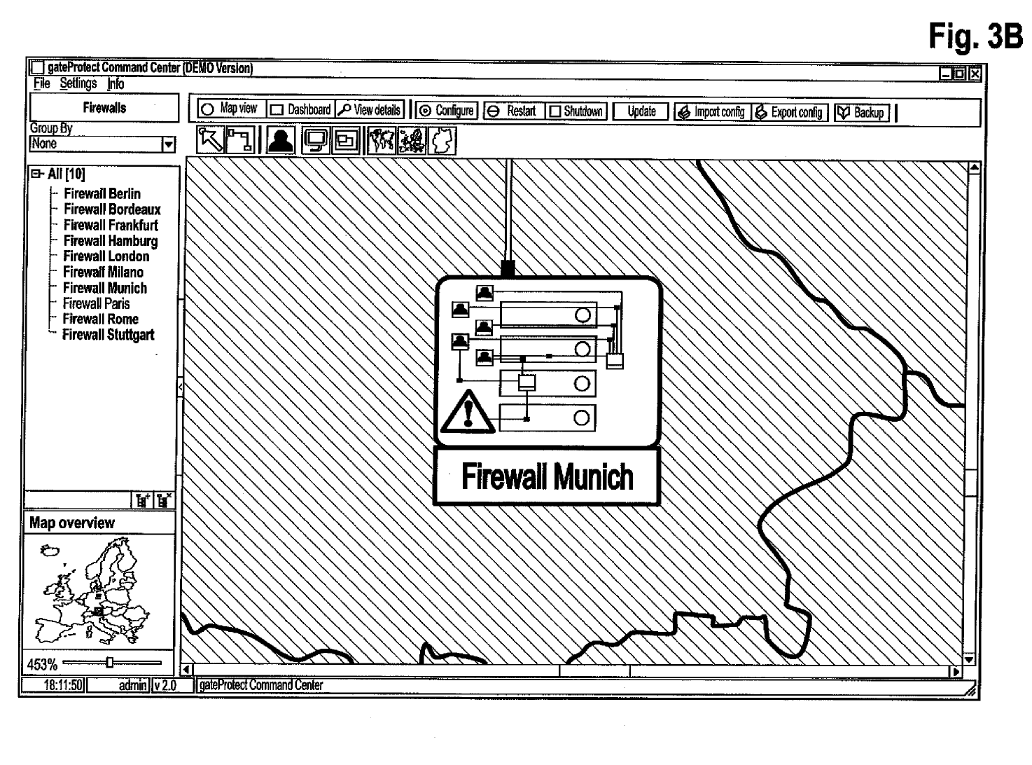

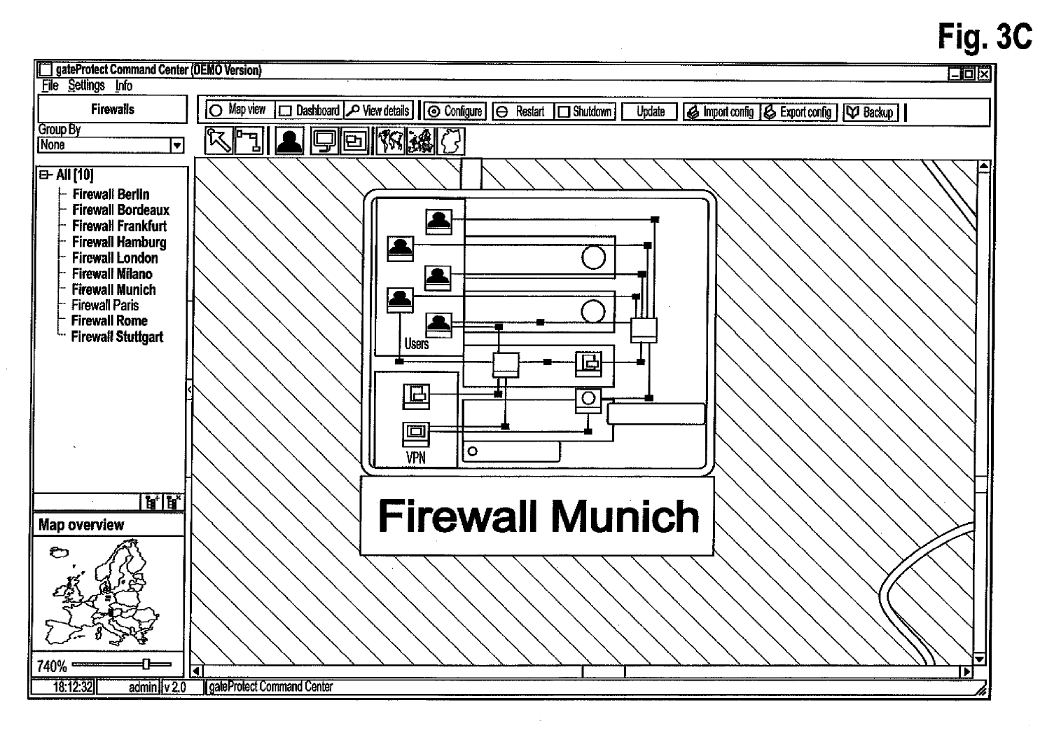

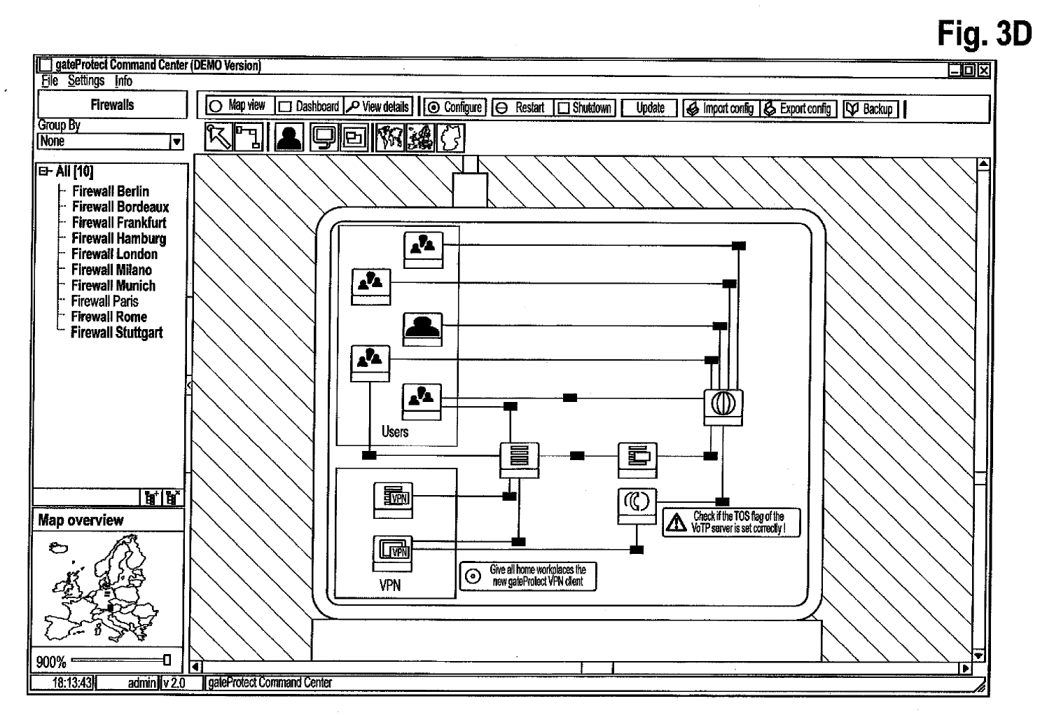

A very important aspect of the invention concerns the size scalable depiction and the variable adaption of functionality provided to the system administrator depending on the degree of enlargement. A corresponding system is exemplarily shown in FIG. 3. In this embodiment of the invention not to be considered as restrictive, a Windows program is depicted on a display device to allow the inventive arrangement of the particular symbols on the viewing screen. The employed window consists of different sub-regions. The main part is the depiction of the firewall, devices and the VPN tunnels connecting them as such, where in the present example a map showing Middle Europe is underlaid in order to allow for an even better display of the spatial relations. Furthermore, there is depicted in the top region to the left a text list with firewalls also depicted, and below this a map overview is depicted showing the map clipping within a greater context which is of relevance in particular for enlarging and reducing since the map can also be scrolled in both dimensions of width and height; and, thereunder, furthermore a bar indicating the degree of enlargement which furthermore comprises a slide roller which can be moved by being gripped with a selection device such as a mouse in order to elect a different enlargement degree which is then depicted after recalculating the display. Above the actual depiction window there is shown a variety of tools. The map shows exemplarily three firewall devices with the firewall Hamburg being connected via two VNP tunnels, to the two firewalls Munich and London. Additionally, a further end user is depicted who is not integrated into the network by means of a firewall.

At about the middle of each VPN tunnel line symbol, a VPN symbol is arranged as a rectangle which is to symbolize the VPN tunnel setting entity. Both the firewall icons and the VPN icons may be clicked on. FIG. 3b shows an enlarged depiction (see left bottom, 453% is given) upon zooming in into the region of the firewall Munich. Here one can see that the display area 24 of this symbol already shows details of the firewall device, i.e. further icons, connecting lines and small boxes for clicking the sub-rule sets. In FIG. 3c this depiction is further enlarged (to 740%), however shows no further details in comparison to FIG. 3b. At nine fold enlargement, i.e. 900% enlargement factor, the maximum is finally reached, at which also the labeling of the symbols is well recognizable. These symbols are now also selectable (in principle as soon as they are visible or only beyond a certain enlargement stage) and may with particular embodiments of the invention furthermore be directly connected with respective symbols in other firewall devices.

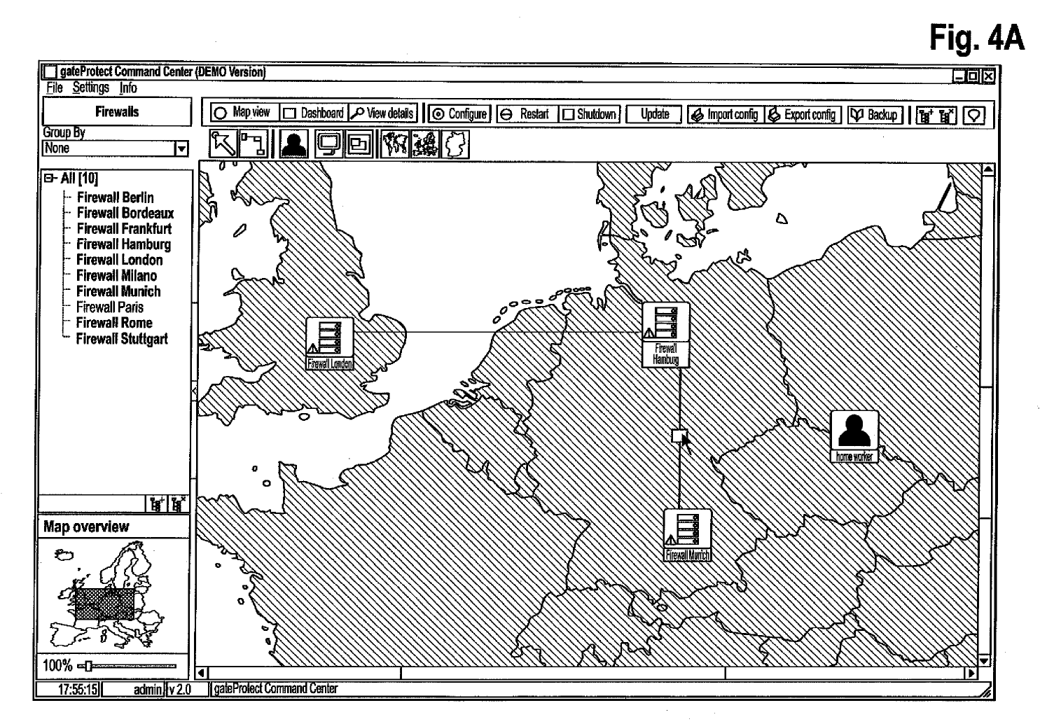

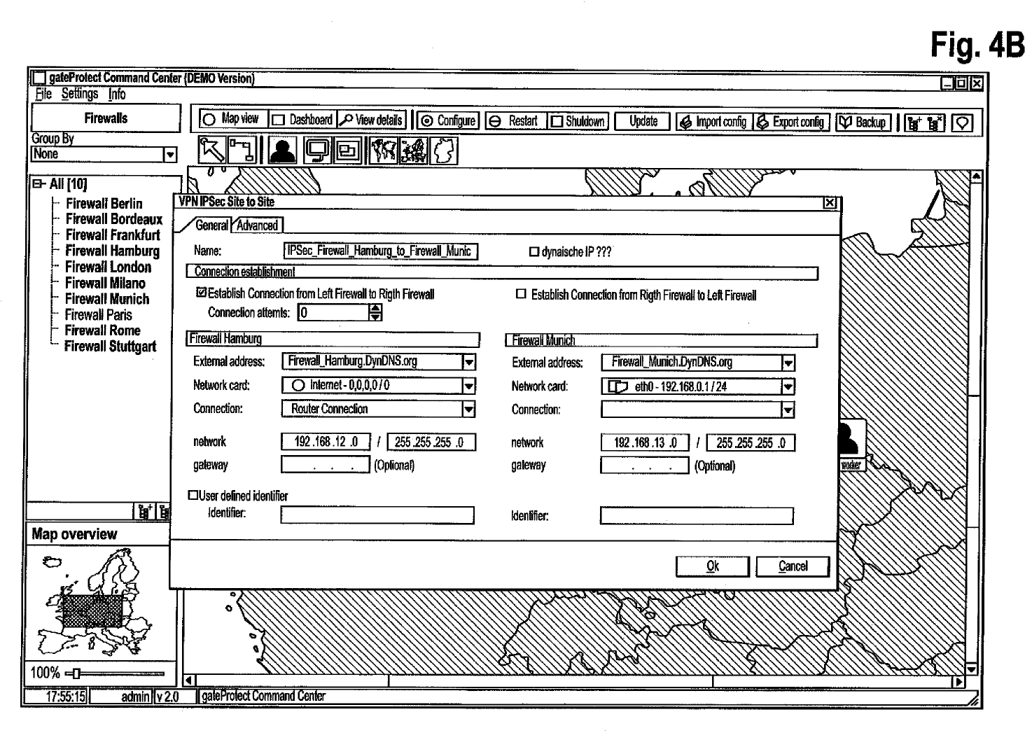

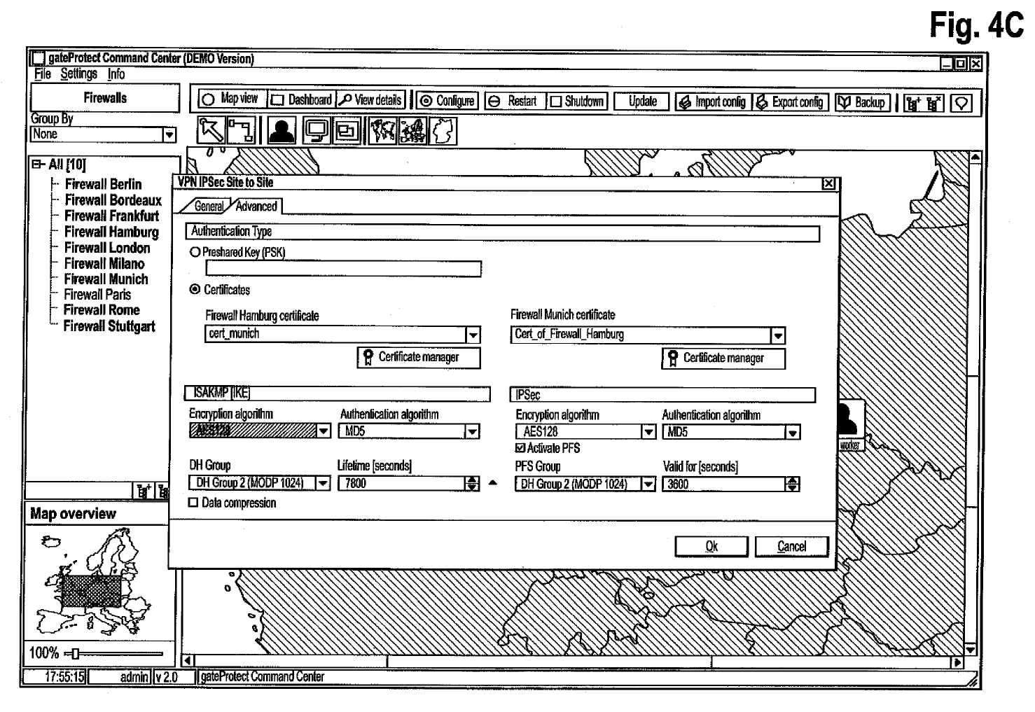

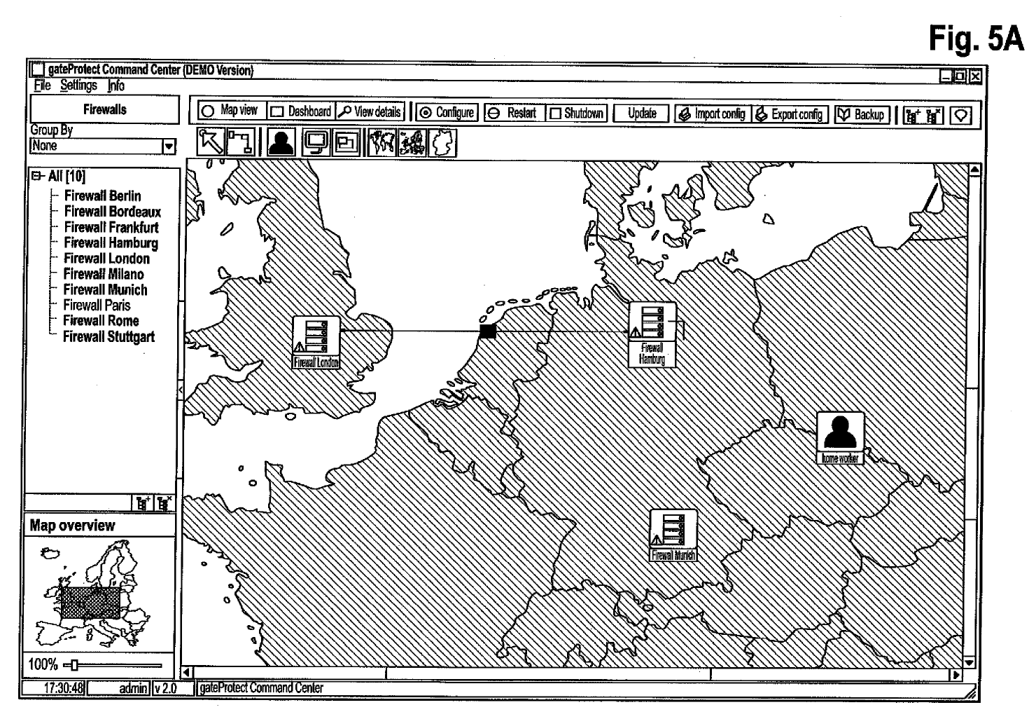

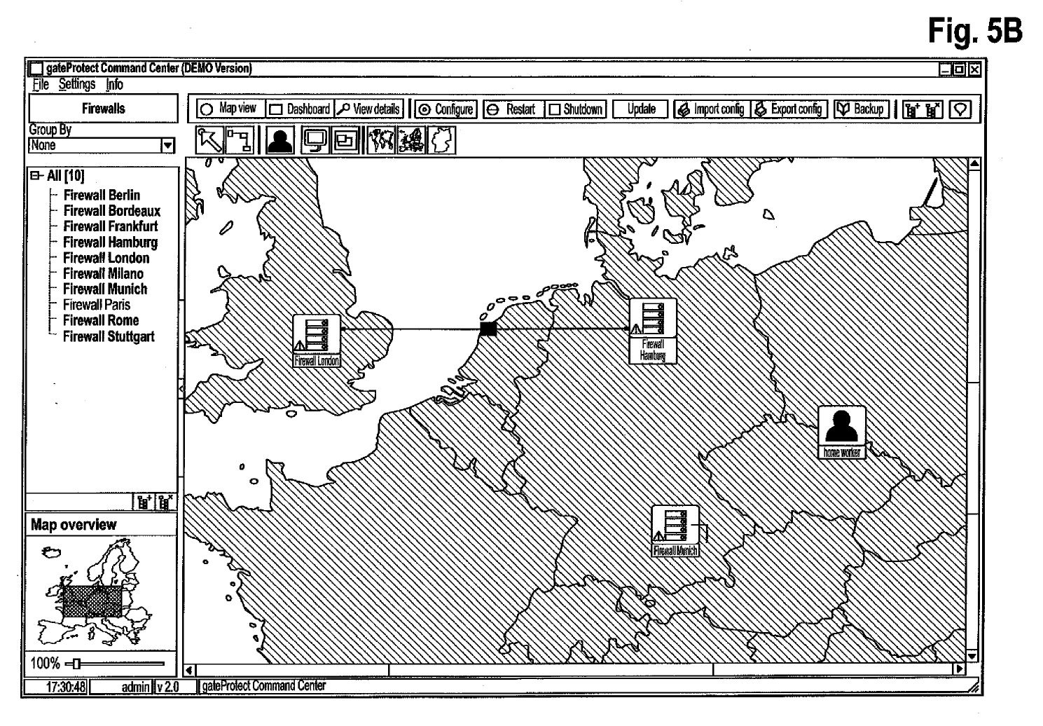

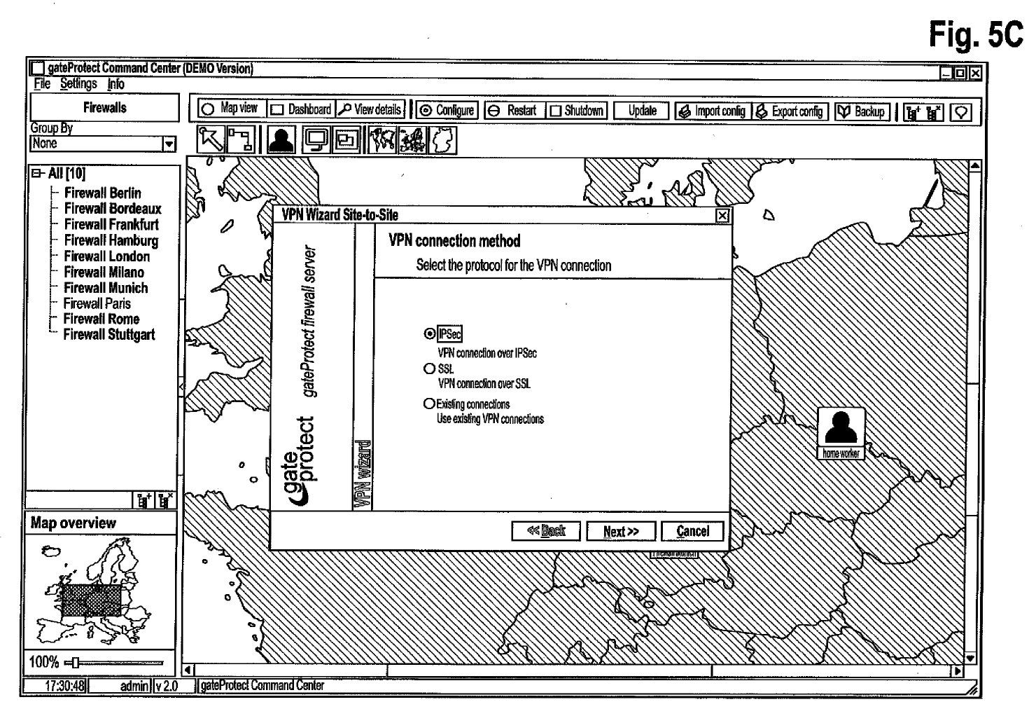

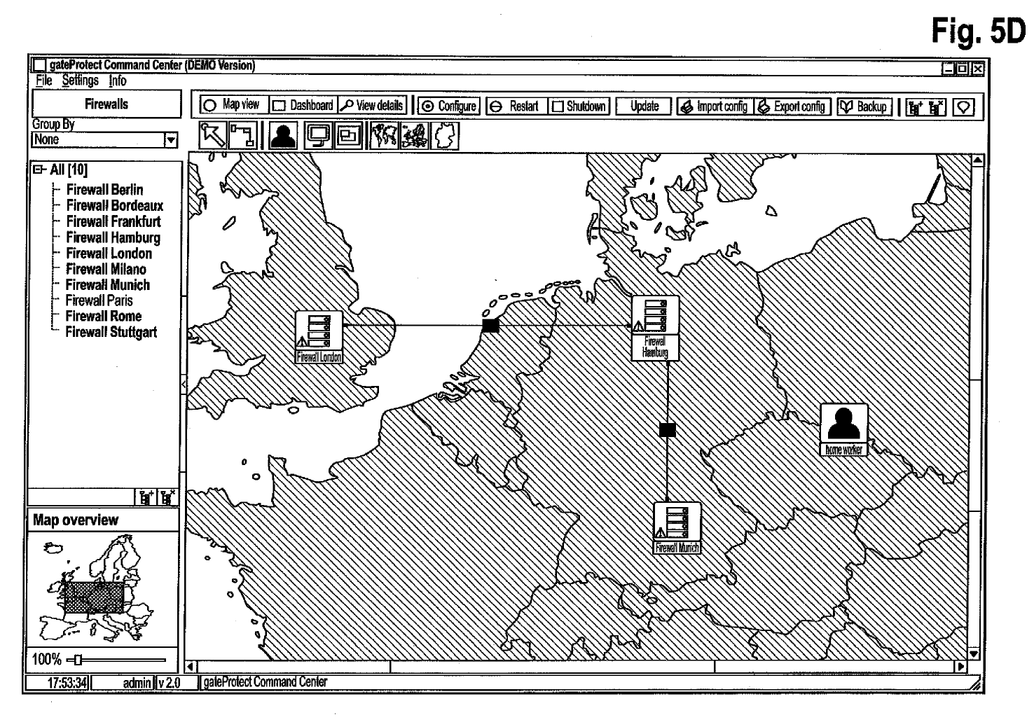

Next, the functionality of starting an editor is to be explained with respect to the pertinent display outputs. FIG. 4 again shows an exemplary program window having a map depiction and several firewall devices arranged thereon, of which the firewall Hamburg and firewall Munich are connected via a VPN tunnel which has just been activated/clicked by means of a selection device (e.g. a mouse), as depicted by highlighting the line and by a highlighting border of the VPN symbol. After double clicking on the VPN symbol, the pertinent VPN tunnel rule editor opens, as shown in FIG. 4b, in the particular case as a further display window on the viewing screen area which is overlaid onto the map depiction. Here, the necessary configuration information regarding those participating firewall devices and their connection states are displayed and may be changed by the system administrator. FIG. 4c shows the possibility of switching to and fro between different functional realms within the VPN tunnel rule editor, by switching to a tab in the top region of the fade-in window. FIG. 5 shows how to set up a new VPN tunnel between two locations in a corporate network. Again, several firewall devices are depicted at different locations, wherein in the present case no connection exists between the firewall device in Hamburg and the firewall device in Munich. Above the window with the map depiction, there are several “buttons” with which a variety of tools of the configuration device may be activated. In the depiction, a tool designated as a line tool is selected which is second from the left. It is possible to draw with this, connecting lines between elements of the map depiction. As depicted in FIG. 5A, a system administrator has activated the firewall device Hamburg. This activation is effected by clicking and is depicted in the map depiction by means of an additional symbol attached to the firewall symbol for line connection. The system administrator now elects, as depicted in FIG. 5B, the firewall device Munich as second firewall to be connected, whereupon the pertinent firewall is indicated with the line tool symbol and the VPN setup editor is started (see FIG. 5C). This is a so-called wizard which guides the system administrator through the required steps of setting up a VPN tunnel between the two firewall devices selected before. In FIG. 5D, the configuration is finished and the VPN tunnel connection between the two firewall devices is depicted as established.

In the following, the inventive method and the inventive configuration device will be further explained with the help of several flowcharts which are to be considered as exemplary embodiments of the invention.

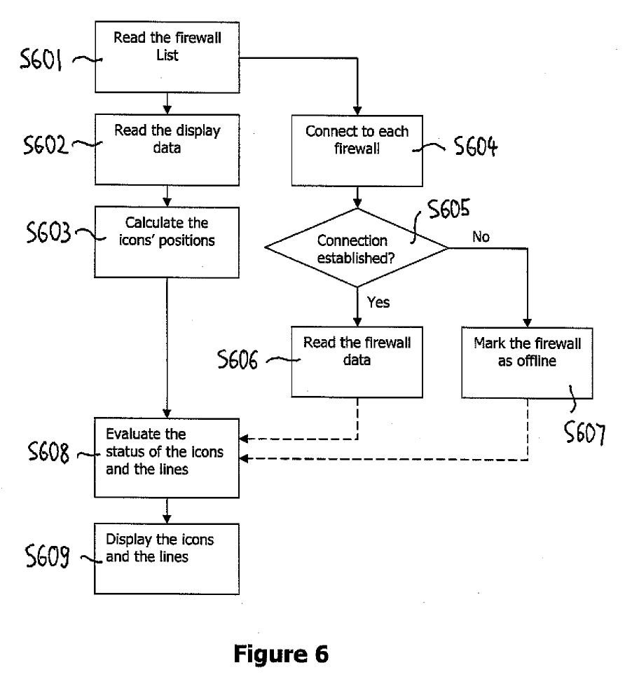

FIG. 6 shows in a first flowchart an initialization routine according to the method and for use with the configuration device. In step S601 the so-called firewall list is read into the system. This list contains information on the firewalls to be managed and optionally supplementing information, such as the location. Thereafter, in step S602 display data are read in, as for example the symbols required for the depiction, maps etc. In step S603, the symbol and icon positions are then calculated on the depiction area available therefor on the viewing screen including, if designated, a pertinent map depiction. In a parallel thread, a link with the particular firewalls contained in the firewall list is established in step S604. If it is possible to establish a connection, as is queried in step S605, the firewall data still required are read out from the firewall (step S606). If a connection to the firewall is not possible, this firewall is designated as “off” in step S607. The results of steps S603, S606 and S607 are then further processed in step S608, in which the status of the icons to be inserted and the lines is calculated depending on the firewall data and the offline/online state thereof. Finally, actual depiction of the various symbols such as icons and lines is effected in step S609.

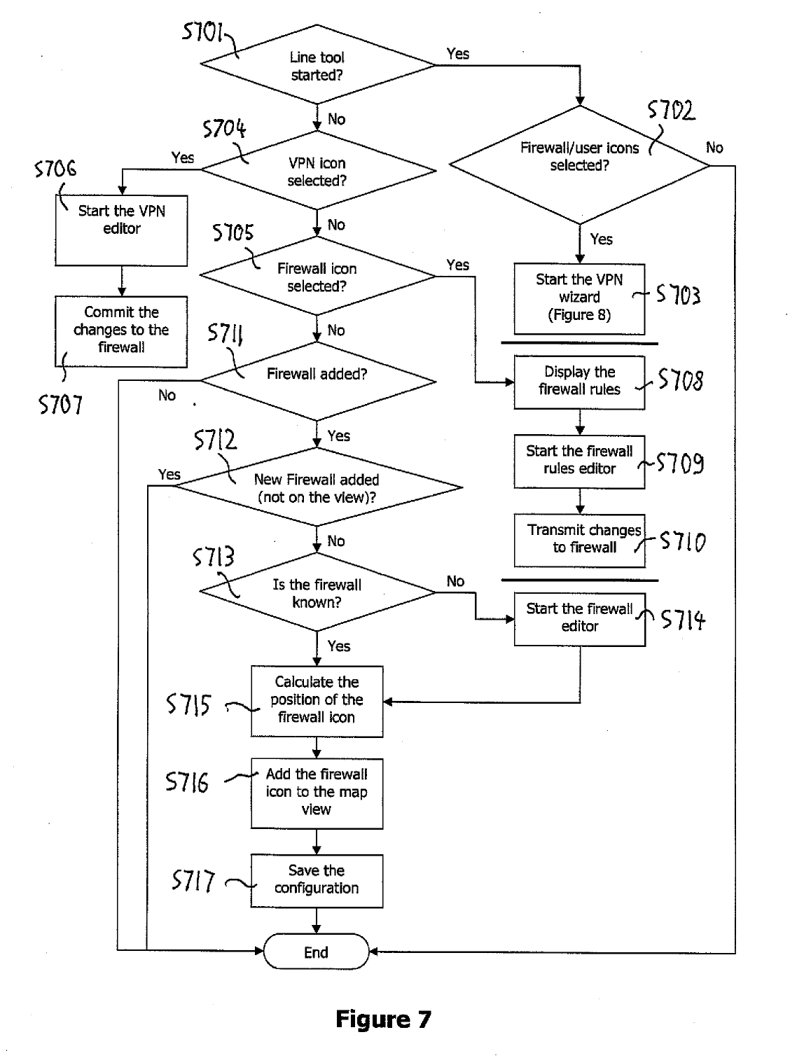

Now, in FIG. 7 a flowchart is presented that should explain the actual interactive actions of the system administrator with the inventive configuration device, and when using the method. The six rhombuses arranged below each other serve as starting points to be polled, in a variety of sub routines, and can be implemented in a manner known to skilled persons, for example by event handling or similar approaches. In step S701 it is first checked whether a line tool has been started. This is for the drawing of new connecting lines and activation of setup programs. In the present case, provided a line tool has been started, it is checked in step S702 whether firewall or user symbols have been selected which are to be configured, in order to establish a new VPN tunnel. If this is the case, in step S703 the VPN Wizard is started, which acts as a setup tool. If no line tool has been started, the method proceeds to a “normal” configuration operation. It is checked thereby in step S704 whether a VPN symbol has been selected and in step S705 whether a firewall symbol has been selected. If a VPN symbol has been identified as being selected, the VPN rule editor will be started in step S706. After effecting the desired changes to the VPN tunnel setting by a system administrator, the changes are then written back to the firewall device in step S707. If a firewall symbol is determined as being selected (step S705), first of all, the firewall rules are depicted in step S708 and then the firewall rule editor is started in step S709. After effecting changes to the rules in question by a system administrator, the changes are transmitted back to the pertinent firewall device in step S710.

Furthermore, in step S711 it is determined whether a firewall has been added (not shown) and if this is the case, it is furthermore checked whether a new firewall has been added, i.e. a firewall that had not previously been on the view (also not shown). Next, it will be checked whether a firewall is known or not (step S713) and if the firewall was not known to the system, the firewall editor is started for the configuration thereof (step S714). When the firewall has been identified as known in step S713 and/or after finishing the use of the firewall editor, the firewall icons are calculated anew in step S715 with respect to their position, and in step S716 the respective firewall symbol is added to the depiction. Afterwards, to end the exemplary method in step S717, the configuration is stored.

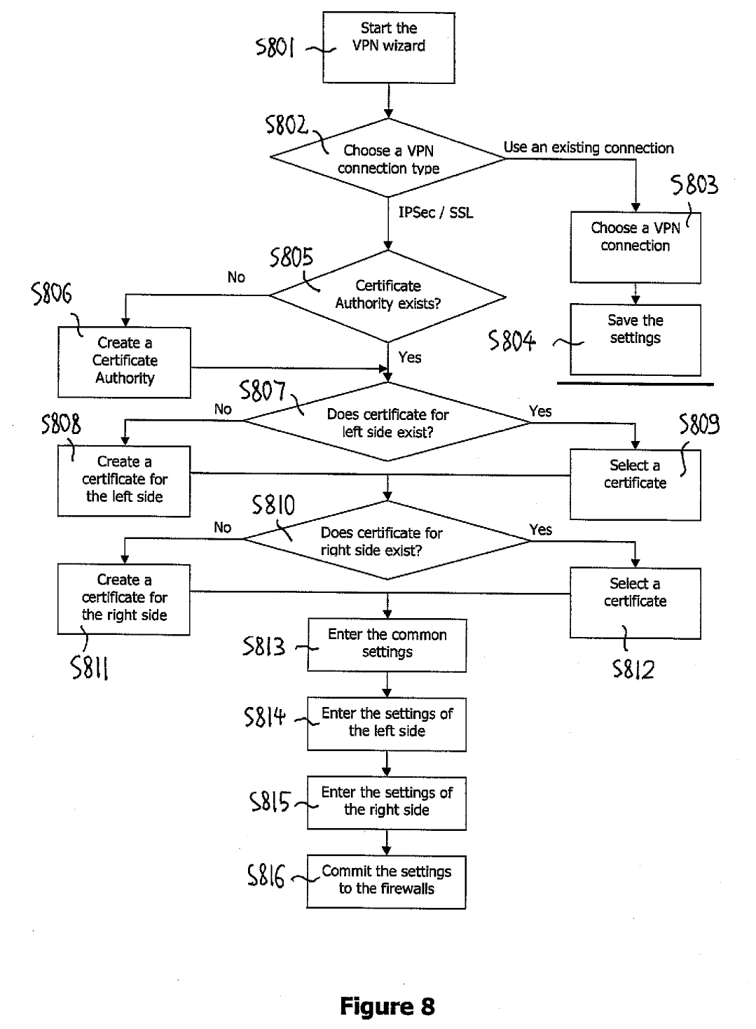

Finally, FIG. 8 shows exemplarily a flow chart for the functionality of the “VPN Wizard” or of the VPN tunnel setup unit. Here, after starting the VPN-Wizard in step S801, the type of VPN tunnel is selected in step S802, and depending thereon it is decided whether an existing connection is to be used which is then selected in step S803, and the settings thereof are stored in step S804.

If IPsec/SSL is selected, it is checked in step S805 whether a CA certificate is already existing or not. If such a certificate cannot be found, it must be produced in step S806 and is supplied to the processing flow. Either with a certificate newly generated in step S806 or one already recognized in step S805, the next querying step is performed with which it is clarified in step S807 whether the one side, designated here as left side, of the VPN tunnel to be set up, has a certificate and, depending thereon either a certificate is generated (step S808), or a certificate selected (step S809), whereupon as a second part of the check, it will be determined whether a certificate for the other side, designated here as right side, of the VPN tunnel exists (step S810). Depending on the result, a new certificate is generated for this side either in step S811, or, in step S812 an existing certificate is selected. Thereafter, the method proceeds to the input of the general settings, which are interactively effected by a system administrator on a viewing screen display (step S813). Thereafter, individual settings are effected for the left side in step S814, and for the right side in step S815, hence completing the configuration of the new VPN tunnel by the VPN Wizard, and in step S816 the changed or effected settings are transmitted back to the pertinent firewalls.

1. Configuration device for configuring a plurality of firewall devices which are positioned in at least one computer network, comprising:
a display device for depicting firewall symbols representing firewall devices in an arrangement representing the actual spatial location relation of the firewall devices; for depicting line symbols representing VPN tunnels between mutually connected firewall devices, and for depicting VPN symbols representing VPN tunnel setting entities, on or at the line symbols,
a selection device for selecting firewall devices and VPN tunnel setting entities through their firewall symbols and VPN symbols, on the display device,
a firewall rule editing unit for editing a configuration and/or rules of a selected firewall device, based upon starting configuration data and starting rules for the selected firewall device, received via the computer network, and
a VPN tunnel editing unit for editing the settings of a selected VPN tunnel setting entity, based on starting settings for the selected VPN tunnel from the firewall devices participating in the VPN tunnel, which are received via the computer network.

2. Configuration device according to claim 1, wherein the editing units are configured for depicting the configuration data, rules and/or settings as well as their editing function on the display device.

3. Configuration device according to claim 1, wherein the display device comprises a zooming unit for size-variable depiction of the symbols on the display device and the display device is configured for changing the depiction—with increasing size smoothly and/or in stages—of the firewall symbols, and if need be, of the length and potentially thickness of the line symbols and/or VPN symbols in a way that an increasing number of information with respect to configurations and/or partial rule sets of the logical elements within the firewall devices on the display area of the firewall symbols are depicted.

4. Configuration device according to claim 3, wherein the information on the display area of each of the firewall symbols may comprise sub-rule symbols representing sub-rule sets having rules for each of the logical connections between computers and a computer network.

5. Configuration device according to claim 4, wherein the selection device furthermore is for selecting sub-rule sets via their sub-rule symbols on the display area of the firewall symbols and the configuration device furthermore comprises:
a sub-rule editing device for editing the configuration of a selected sub-rule set, based on initial configuration data and rules for the selected sub-rule set which are received from the firewall device, to which the sub-rule set belongs, via the computer network.

6. Configuration device according to claim 1, furthermore comprising a VPN tunnel set-up unit for setting up and configuring settings of a new VPN tunnel between at least two firewall devices which will automatically start after activating the VPN tunnel set-up unit by the selection device by means of successive selecting of firewall symbols of two firewall devices to be mutually connected.

7. Configuration device according to claim 6, wherein the VPN tunnel set-up unit is configured for retrieving initial settings from the firewall devices participating in the connection to be set-up, and for reconfiguring the settings and/or the security certificates to the firewall devices after setting up by a system administrator for the VPN tunnel set up unit.

8. Configuration device according to claim 1, wherein the display device is furthermore provided for the depiction of user devices which are not firewall protected, represented by user symbols in an arrangement on the display device in a relation representing their actual spatial location relation, and the line symbols also serve for depicting VPN tunnel connections between the user devices and the firewall devices.

9. Configuration device according to claim 8, furthermore comprising a user set-up unit for setting up and configuring a new VPN tunnel between a firewall device and a user device, which is for an automatic start after activating user set-up units with the selection device by successively selecting the symbols of the firewall device and the user device to be mutually connected.

10. Configuration device according to claim 9, wherein the user set-up unit is configured to read-in the starting settings from the devices participating in the VPN tunnel to be set up, and to reconfigure settings and/or security certificates in the devices, after their set-up by a system administrator for the user settings.

11. Configuration device according to claim 6, wherein the VPN tunnel set-up unit and/or the user set-up unit, upon enlargements of the depiction in the display unit, in which information with respect to configuration and the rule sets within the firewall devices (display area) of the firewall symbol is depicted, is also activatable when selecting logical elements and/or sub-rule sets within the display area of firewall symbols and is for automatically linking such internal logical elements with logical elements in this or other firewall devices.

12. Configuration device according to claim 1, wherein the display device comprises a correlation unit arranged for determining the positioning of the symbols belonging to the devices and, derived therefrom, of connecting lines and their VPN symbols on the display device, by means of site location data from the firewall devices and the user devices.

13. Configuration device according to claim 12, wherein the site location data in the firewall devices are site location data originating from localization devices in the firewall devices, wherein the localization devices are configured to automatically determine the site location.

14. Configuration device according to claim 1, wherein the depiction comprises an underlaid mapping depiction upon which the firewall devices and/or the user devices are arranged corresponding to their actual spatial site relation.

15. Method for configuring firewall devices and relations between firewall devices in a computer network, the method comprising the steps:
depicting of firewall symbols representing firewall devices in an arrangement representing their actual spatial relation, of line symbols representing VPN tunnels between interconnected firewall devices as well as VPN symbols representing VPN tunnel setting entities on or at the line symbol, on a display device;
after selecting a firewall symbol on the display device by a system administrator, starting a firewall rule editing unit for editing a configuration and/or rules of a selected firewall device, based on initial configuration data and rules for the selected firewall device which are received through the computer network; and/or
after selecting a VPN symbol on the display device by a system administrator, starting a VPN rule editing unit for editing settings of a selected VPN tunnel setting entity, based on initial settings for the selected VPN tunnel from the firewall devices participating in the VPN tunnel, which are received through the computer network.

16. Method according to claim 15, further comprising the step of:
writing back the configuration, rules and/or settings changed by the system administrator using the firewall rule editing unit and/or the VPN tunnel editing unit to the concerned firewall devices.

17. Method according to claim 15, wherein configuration data, rules and/or settings as well as possible editing functions are depicted on the display device.

18. Method according to claim 15, wherein the depiction of the symbols on the display device, with the firewall symbols being depicted in an altered manner with increased size in steps or smoothly, so that an increasing amount of information on the configuration and/or sub-rule sets of the logical elements within the firewall devices are depicted on display regions of the firewall symbols.

19. Method according to claim 18, wherein sub-rule symbols representing sub-rule sets with rules for individual logical connections between computers in the computer network are depicted on the display area of each firewall symbol.

20. Method according to claim 18, comprising the following further steps:
selecting sub-rule sets by means of their sub-rule symbols on display areas of the firewall symbols; and
editing the configuration of a selected sub-rule set based on initial configuration data and rules for the selected sub-rule set (if necessary analogically interpreting the capability of the terms as in the rule set), which are received from the firewall device to which the sub-rule set belongs, via the computer network.

21. Method according to claim 15, comprise the following steps:
activating a mode for setting up connections between firewall devices;
successively selecting the symbols of at least two firewall devices to be mutually connected; and
starting a VPN tunnel setup unit for setup and configuration of a new VPN tunnel between the selected firewall devices.

22. Method according to claim 21, wherein the VPN tunnel setup unit performs the following steps after being started:
retrieving the initial settings from the firewall devices participating in the connections to be set up, and
reconfiguring the settings and/or the security certificates at the firewall devices after setup by a system administrator for the VPN tunnel configuration.

23. Method according to claim 15, wherein also symbols representing user devices which are not firewall protected are depicted on the display device in an arrangement representing their actual spatial location relation; and
the line symbols also serve to depict VPN tunnel connections between user devices and firewall devices.

24. Method according to claim 23, comprising the further steps:
activating a mode for establishing connections between at least one firewall device and at least one user device;
successively selecting the symbols of the firewall device and user device to be mutually connected; and
starting a user setup unit for setting up and configuring a new connection between the selected firewall device and the selected user device.

25. Method according to claim 21, wherein, upon enlarging the depiction on the display unit in which information on configurations and rule set content of the firewall devices are depicted, the VPN tunnel setup unit and/or the user setup unit are also started upon selection of logical elements and/or sub-rule sets within the display area of firewall symbols and an automatic link between such internal elements will be established with elements in this or other firewall devices.

26. Method according to claim 15, comprising the further step:
determining the positioning of the symbols belonging to the devices and deduced therefrom, of connecting lines on the display device by means of location data from the firewall devices and the user devices.

27. Method according to claim 26, wherein the method comprises the following further steps:
in the firewall device, determining a present location of the firewall device by means of localization device, such as a GPS receiver, etc., in the firewall device; and
making available the information on the location at the configuration device, for determining the positioning of symbols on the display unit.

28. Computer network security system, comprising
a plurality of firewall devices which may be physically and/or logically connected, and
at least one configuration devices according to claim 1.

29. Program code to be executed on a data processing facility, for configuring firewall devices and relations between firewall devices in a computer network, comprising the program steps:
depicting firewall symbols representing firewall devices in an arrangement representing their actual spatial relation, line symbols representing VPN tunnels between interconnected firewall devices as well as VPN symbols representing VPN tunnel setting entities on or at the line symbol, on a display device;
after selecting a firewall symbol on the display device by a system administrator, starting a firewall rule editing unit for editing a configuration and/or of rules of a selected firewall device, based on initial configuration data and rules for the selected firewall device which are received through the computer network; and/or
after selecting a VPN symbol on the display device by a system administrator, starting a VPN rule editing unit for editing settings of a selected VPN tunnel setting entity, based on initial settings for the selected VPN tunnel from the firewall devices participating in the VPN tunnel, which are received through the computer network.

30. Program code according to claim 29, comprising the further programming step:
writing back of the configuration, rules and/or settings changed by the system administrator using the firewall rule editing unit and/or the VPN tunnel editing unit to the concerned firewall devices.

31. Program code according to claim 29, wherein configuration data, rules and/or settings as well as possible editing functions are depicted on the display device via the program code.

32. Program code according to claim 29, wherein depiction of the symbols on the display device is e.g. enlarged or reduced by the program code, and the firewall symbols are depicted in an altered manner with increased size in steps and/or smoothly, so that an increasing amount of information on the configuration and/or sub-rule sets of the logical elements within the firewall devices are depicted on display regions of the firewall symbols.

33. Program code according to claim 29, wherein sub-rule symbols representing sub-rule sets with rules for individual logical connections between computers in the computer network are depicted on the display area of the display device.

34. Program code according to claim 29, comprising the further program steps of:
selecting sub-rule sets by means of their sub-rule symbols on display areas of the firewall symbols; and
editing the configuration of a selected sub-rule set based on initial configuration data and rules for the selected sub-rule set (if necessary analogically interpreting the capability of the terms as in the rule set), which are received from the firewall device to which the sub-rule set belongs, via the computer network.

35. Program code according to claim 29, comprising the following program steps:
activating a mode for setting up connections between firewall devices;
successively selecting the symbols of at least two firewall devices to be mutually connected; and
starting a VPN tunnel setup unit for setup and configuration of a new VPN tunnel between the selected firewall devices.

36. Program code according to claim 29, wherein the VPN tunnel setup unit performs the following steps after being started:
retrieving the initial settings from the firewall devices participating in the connections to be set up, and
reconfiguring the settings and/or the security certificates at the firewall devices after setup by a system administrator for the VPN tunnel configuration.

37. Program code according to claim 29, wherein furthermore symbols representing user devices which are not firewall protected are depicted on the display device in an arrangement representing their actual spatial location relation; and the line symbols may also serve to depict VPN tunnel connections between user devices and firewall devices.

38. Program code according to claim 37, comprising the following program steps:
activating a mode for establishing connections between at least one firewall device and at least one user device;
successively selecting the symbols of the firewall device and user device to be mutually connected; and
starting a user setup unit for setting up and configuring a new connection between the selected firewall device and the selected user device.

39. Program code according to 35, wherein, upon enlarging the depiction on the display unit in which information on configurations and rule set content of the firewall devices are depicted, the VPN tunnel setup unit and/or the user setup unit are also started upon selection of logical elements and/or sub-rule sets within the display area of firewall symbols and an automatic link between such internal elements with elements in this or other firewall devices is established.

40. Program code according to claim 29, comprising the further step:
determining the positioning of the symbols belonging to the devices and deduced therefrom, connecting lines on the display device by means of location data from the firewall devices and the user devices.

41. Program code according to claim 40, comprising the further program steps:
in the firewall device, determining a present location of the firewall device by means of localization device, and
making the information on the location at the configuration device available for determining the positioning of symbols on the display unit.
